(19) United States
(12) Patent Application Publication
(10) Pub. No.: US 2011/0004893 A1
(43) Pub. Date: Jan. 6, 2011

(54) DEVICES AND TECHNIQUES FOR DETERMINING AND FACILITATING AUTHORIZED DISTRIBUTION OF MEDIA CONTENT

(76) Inventors: Daniel M. BORISLOW, Palm Beach, FL (US); Gregory Lynn Wood, Oneonta, AL (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 12/497,312

(22) Filed: Jul. 2, 2009

(51) Int. Cl. H04N 7/16; H04W 24/00

(52) U.S. Cl. 725/25; 455/456.5; 725/68; 725/34; 455/457; 725/119

(57) ABSTRACT

A module for use in connection with a media content set-top box is described. The module may include a communications node configured to interface with the media content set-top box that receives media content, a receiver and/or transceiver and control logic. The control logic is configured so as to receive one or more first signals, via the receiver and/or transceiver, carrying corresponding one or more CMRS tower, wireless access point, and/or transmitter identifiers, to determine one or more signal strengths of the one or more first signals, and to obtain a location of the device. The location of the device can then be used to provide location specific media content or information alerts and/or to facilitate the determination of whether a use of the device, a use of an associated media content set-top box, etc., at the location is authorized.

### TECHNICAL FIELD

This invention is applicable at least in the fields of media content provision, e.g., satellite, digital, and cable television service provision, and, more particularly, in the field of devices, systems, processor program products, and methods of facilitating such services.

### BACKGROUND

As technology has progressed, media content providers have optimized systems for allowing satellite, digital and cable television subscribers around the world to receive media content such as digital television signals with the use of small, potentially portable consumer electronics. A typical conventional digital television receiving system includes, at the subscriber end, an outdoor satellite dish, a Low Noise Block-downconverter (hereinafter referred to as “LNB”), and an indoor Set-Top-Box (hereinafter referred to as “STB”). When the satellite dish receives a satellite signal from a commercial satellite, the LNB processes the satellite signal through a series of amplification, frequency down-conversion, wave filtration and frequency stabilization treatments into a multi-band baseband signal and then outputs the signal to the STB. After demodulating and digitizing the signal, the digital television channels provided by the service provider can be outputted for receiving by the subscriber.

A system provider will generally limit a subscriber's access to digital television signals (digital television programs) via authorization procedures. Typically, the STB has built-in authorization programming, which compares an authorization code carried in the satellite signal provided by the system end to a built-in STB code, and then outputs the digital television signal (program) when the comparison is matched.

A satellite television system provider, particularly one using multiple satellites or spot beams, is capable of broadcasting digital television to different locations around the country or the world. A satellite television system provider may provide different channel programs for different areas, or may charge different rates to subscribers at different locations around the country or the world, or may charge different rates for add-on STBs intended for use with additional television receivers but at a single customer location. However, when a subscriber carries an add-on STB authorized for accessing digital TV signals at a first location in conjunction with a master or companion STB or account at that location, to a different location, or carries an STB to another zone, i.e., any zone where the satellite signal of the system provider is available, the subscriber can watch the digital television without paying the provider the proper charges or without receiving the proper locally-oriented or location specific content.

Therefore, a subscriber can watch digital television channels using an STB acquired from a place with a relatively lower charging rate in a place with a relatively higher charging rate, or can use an add-on STB charged at a relatively lower add-on charging rate at a location different than the master or companion STB or account that warranted the add-on rate. A subscriber can also use an STB to obtain programming at another location but not receive the proper locally-oriented or location specific programming, advertising or alerts. However, because this subscriber is using otherwise authorized hardware, the system provider has no way to know that this subscriber is, or prevent this subscriber from, watching television channels at an unauthorized location or without paying the proper rate for the service, or to target content to the subscriber's actual location. The present invention solves these and other problems involved in the current state of the art, as will be explained below.

### SUMMARY

The present invention is best understood with reference to the claims, the entire specification, and all of the drawings submitted herewith, which describe the devices, systems, processor program products and methods of the present invention in greater detail than this summary, which is merely intended to convey aspects of illustrative embodiments of the present invention.

By way of example, the disclosed devices (e.g., media content set-top boxes, plug-in devices, communication modules, etc.), systems, processor program products and methods may include a combination of hardware and/or software which allows for the determination of the location of the device to thereby facilitate the determination of whether the use of the media content set-top box is authorized at that location. In certain aspects of the disclosure, the device may be configured as a module so as to be integrated as one or more components of a media content set-top box, may be configured as a “plug-n-play” device for use in connection with a media content set-top box, or may be used as a stand-alone communication device in connection with a media content set-top box.

In one embodiment of the disclosure, a module is provided configured to interface with a device that receives media content. By way of example, the device may be a media content set-top box, and may receive digital television programming. In accordance with certain embodiments, the module may comprise: (a) a node configured to interface with the device that receives media content; (b) a receiver and/or transceiver that receives one or more first signals; and (c) control logic that receives from the receiver and/or transceiver the one or more first signals corresponding to one or more commercial mobile radio service (CMRS) (e.g., cellular) tower, wireless access point (WAP), and/or transmitter identifiers that each identify the one or more CMRS towers, WAPs, or transmitters, determines one or more signal strengths of the one or more first signals, and obtains the location of the device based on the one or more CMRS towers, WAPs, or transmitter identifiers and the one or more signal strengths of the one or more first signals to determine whether a use of the device at the location is authorized or whether it is receiving the proper locally-oriented or location specific content.

In another aspect of the disclosure, central processing unit(s), processor(s), controller(s) or control logic used by the disclosed devices are provided that can include the ability to receive from the receiver and/or transceiver one or more first signals carrying corresponding one or more CMRS tower, WAP, or transmitter identifiers that each identify one or more CMRS towers, WAPs, or transmitters, to determine one or more signal strengths of the one or more first signals, and to obtain a location of the device based on the one or more CMRS tower, WAP, or transmitter identifiers and the one or more signal strengths of the one or more first signals. The location of the device can then be used to determine whether a use of the device, a use of an associated media content set-top box, etc., at the location is authorized.

In accordance with an exemplary embodiment of the present disclosure, a communication module is provided for use with a media content set-top box. Again, in certain aspects, the communication module may be integrated as a component of the set-top box, may be a plug-n-play device, or may be a stand-alone device. The communication module includes a node configured to interface with the device that receives media content, a receiver and/or transceiver and control logic. The control logic (a) receives one or more first signals carrying corresponding one or more remote communication device identifiers (e.g., CMRS tower, wireless access point, or transmitter identifiers) that each identify one or more remote communication devices, (b) determines one or more signal strengths of the one or more first signals, and (c) and determines a location of the communication module using the one or more locations of the CMRS towers, wireless access points, or transmitters and the one or more signal strengths of the one or more first signals.

In addition, the location of the communication device may be used to update the location information of the device, e.g., a media content set-top box, automatically or manually. By way of example, if the update is done manually, a user of the device may be prompted to update the location information of the device using the determined location of the device.

The systems and methods disclosed herein also allow the devices (e.g., the plug-n-play devices, media content set-top boxes, etc.) to determine their location and connect to a network (e.g., packet switched network or cellular network) to provide location information to a service provider (e.g., media content service provider, advertising content provider, etc.). For instance, the service provider can then determine whether the use of the devices is authorized at that location. Or, location-specific media content and programming may be authorized and provided based on the determined location. Thus, additional freedom and functionality are provided to the service provider as well as the user, as described in more detail below.

In other embodiments, the systems and methods disclosed herein allow the devices to determine their location and automatically authorize or not authorize content distribution based on the determined location, as described in more detail below.

Additional objects, advantages and novel features of this invention will be set forth in part in the description that follows, and in part will become apparent to those skilled in the art upon examination of the following description, or may be learned by practicing the invention.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIG. 1 illustrates a communication module, according to an embodiment of the disclosure;

FIG. 2 illustrates a media content distribution network, according to an embodiment of the disclosure;

FIG. 3(a) is a flow chart illustrating a process of determining a location of a device, according to an embodiment of the disclosure;

FIG. 3(b) is a flow chart illustrating a process for monitoring the location of multiple devices, according to an embodiment of the disclosure;

FIG. 4 depicts the actual and estimated positions of different components within a communication network and signal strength information pertinent to an exemplary embodiment of the present disclosure.

### DETAILED DESCRIPTION

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention.

The methods and devices of the present disclosure may be used to determine the location of a media content set-top box to facilitate the determination of whether use of the set-top box is authorized. In certain aspects, the location specific authorization techniques may be useful to avoid fraudulent use of an STB by unauthorized users or at unauthorized locations. When an STB is used in connection with a communication module of the disclosure, the STB may be automatically disabled when use is detected at an unauthorized location. The STB may be automatically disabled by the STB itself, or by a remote service or device (e.g., a media content service provider, etc.). Alternatively, the media content service provider may be alerted of the use of an STB at an unauthorized location for further investigation and/or action (rather than automatic disablement of the STB).

In other aspects, the location specific authorization techniques may be used to allow site specific use of an STB in an authorized manner. For example, a user may validly move an STB between multiple registered, authorized locations (a primary residence, a vacation home, a work location, etc.). The user may validly receive authorized media content at all locations. However, without appropriate location monitoring, location specific programming is not available and location specific pricing structures cannot be properly implemented. When an STB is used in connection with a communication module of the disclosure, the location of the STB may be determined, and authorized, location specific programming may be provided to the user (including location specific pricing, programming, advertising, and alert systems). In other aspects, the location of multiple STBs intended for use at a single, authorized location may be monitored (i.e., the use of a primary STB in conjunction with “add-on” STBs at the same location).

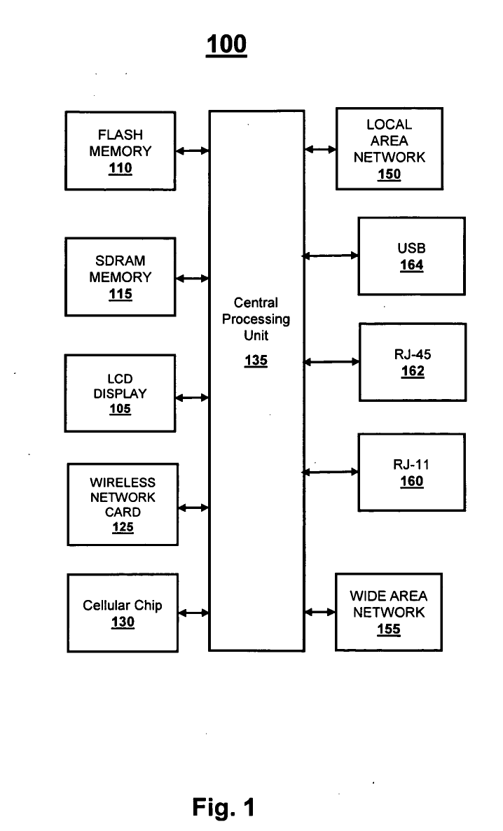

Without being limiting, FIG. 1 illustrates the components of a particular device, which is a communications module 100, such as a plug-n-play type module, e.g., a universal serial port (USB) module, according to one embodiment of the disclosure. However, these components, or a subset of these components, may be employed in a number of other systems and devices of the present disclosure.

By way of example, the components described in connection with the communications module 100 and the manner in which they are employed may be the same for other devices, including as integrated components of a media content set-top box (e.g., satellite television or digital cable television set-top boxes) and stand-alone communication devices for use with such set-top boxes (STBs). Accordingly, the description of the communications module 100 set forth herein and reflected in the drawings may be read more broadly as merely an example of the types of features that other devices, such as STBs, may have that implement the present disclosure. In some instances, the components of the communications module may be incorporated in an STB, and so no separate communications module may be required.

The module 100 may include a central processing unit 135. The CPU 135 controls the module 100 via programmable software. The CPU 135 is a microprocessor, of a kind that is well known to one of ordinary skill in the art. Integrated into the CPU 135 may be digital signal processor software (not shown) which processes location data in real time.

Connected to the CPU 135 may be several memory devices, such as flash memory 110 and SDRAM 115. The flash memory 110 may be used to store information permanently, such as configuration information and program code, including when the module 100 is not powered or is turned off. The SDRAM 115 may be used as a working storage for the CPU 135 during operation. The module 100 may have the capability to be attached directly to, e.g., an STB, via a USB or other connector 164.

Also connected to the CPU 135 may be a cellular chip 130, wireless network card 125, and/or stand-alone receiver (not shown) implementing a receiver and/or transceiver which allows the module 100 to access or monitor a cellular or wireless network. The cellular chip 130, wireless network card 125, or stand-alone receiver may be connected to the CPU 135 or it may be integrated with the CPU 135 on a circuit (with or without other components). The cellular chip 130, wireless network card 125, stand-alone receiver and/or CPU 135 monitor signals received from commercial mobile radio service (CMRS) towers (e.g., cellular), wireless access points (WAPs), and/or transmitters; gather CMRS tower, WAP, or transmitter identifiers from these signals; determine signal strength; and upon receipt of the locations derived from the identifiers, calculates the position of the module 100. Any combination of CMRS towers, WAPs, and/or transmitters may be monitored in connection with the present invention, limited only by desired communications and access to signals. As discussed in more detail below, a wireless card 125 may also be connected to CPU 135 so as to facilitate communication with WAPs.

In one embodiment, a wireless network card 125 may be connected to the CPU 135. Also, the wireless network capability may be built into the module 100 in the form of semiconductor and/or integrated circuit/device(s) without the use of a separate card. The wireless network card 125 allows the module 100 to access or monitor any one or more of available wireless networks. The wireless network card 125 may, for example, use a variation of the IEEE 802.11 standard to transmit information to or monitor the network(s). One of ordinary skill, however, can appreciate that other methods can be employed as well. The wireless network card 125 may be built into the module 100 via a replaceable module, or connected to the module 100 via any appropriate standard such as PCI, PCMCIA, or USB. By employing a particular wireless network card, a user can have access to any number of wireless networks such as Wi-Fi, Wi-Max, EV-DO, HSPDA, GSM, CDMA or any other wireless network that exists or may be developed. If desired, the wireless network can then be used to communicate (e.g., the location of the adaptor 100 and the associated STB) with a media content service provider. In addition, the wireless card can be used to monitor WAPs as discussed herein for identifiers and signal strength to aid in location identification of the device.

In yet another embodiment of the disclosure, the module 100 can be adapted to include multiple wireless network cards. The multiple wireless network cards feature would allow the user flexibility to employ different types of wireless network services, such as Wi-Fi and cellular broadband wireless. One of ordinary skill can appreciate that many different services can be employed and the example is used for illustration and not as a way of limitation. The circuitry could be adapted to include, for example, a mini-PCI card and another mini-PCI card or other replaceable module, such as PCMCIA, USB or PCI. The CPU 135 would include software which would allow the network interface to adaptively switch between using the wireless network cards, or the wireless cards and the cellular chip 130, to receive identifier/signal strength information from WAPs (or CMRS towers if a cellular chip is used); transmit, e.g., status and/or location information; and to allow a user to replace wireless network cards/cellular chips during the operation of the module 100. For example, when the module 100 is not in range of a router via Wi-Fi or other wireless network, the module 100 would transmit the packetized location information via a broadband cellular network like EV-DO or another applicable cellular broadband network to which the user or the media content service provider has a subscription or other right to communicate.

The CPU 135 and/or cellular chip 130 and/or wireless network card 125 monitor signals received from one or more cell towers, wireless access points, and/or transmitters to determine their identifiers and also monitor the corresponding signal strength for each of those signals using the above-mentioned signal strength monitoring circuitry and/or software. The identifiers and corresponding signal strengths may be stored in local flash memory (e.g., memory 110 and/or SDRAM 115). In accordance with one embodiment, the CPU 135 will then query a database system (e.g., without being limited, such as that which is provided by Mexens Technology via web service APIs which are offered as part of its NAVIZON positioning system, or GOOGLE MAPS) to identify a latitude and longitude for each cell tower, wireless access point, and/or transmitter, and thereafter use the latitude and longitude and the signal strength for each cell tower, wireless access point, and/or transmitter, to calculate a location for the module 100 using well-known triangulation techniques. Without being limiting to the present disclosure, an example of such a technique is described in U.S. Pat. No. 7,397,424, which is incorporated herein by reference. Alternatively, the CPU 135 may query a server and/or database system with the latitude and longitude of each cell tower, wireless access point, and/or transmitter, along with its corresponding signal strength, and have the database system return location identifying information for the module 100, such as a calculated location of the module 100 expressed in the form of latitude and longitude coordinates and/or physical address.

In certain embodiments, the local position of the module 100 may be used to update the location of the module 100 with a service provider if desired (i.e., provide a registered location with a service provider), and/or may be transferred to a media content service provider to facilitate determination of whether a particular use of an STB is authorized (based at least in part on identifying the location of the module 100) or to assist in delivery of location-specific content such as programming, advertising, and/or alerts. In other embodiments, the CPU 135 automatically disables an STB or instructs an STB to shut down or disable itself if the local position of the module 100 is determined to be an unauthorized location.

Although the local position (and/or registered location) of the module 100 may be forwarded to the media content service provider via a cellular network, it may also be sent to the media content service provider via a packet switched network, via a VoIP network, via a landline phone network, etc. For example, in certain embodiments, the cellular chip 130, wireless card 125, or other suitable communications node (RJ-11, RJ-45, etc.) receives location data from the CPU 135 and modulates and transmits the data in a known way to communicate with another device via the cellular network, packet-switched network, landline-phone lines, etc., depending on available communication lines. In an embodiment of the disclosure, the CPU 135 may execute software that routes communications to any desired communication network, as recognized by those skilled in the art, depending on which network type or types are detected or preferred.

The LCD display 105, which is an optional feature of the communication module 100, may then be used to display information to a user, for example concerning diagnostic and status information of the module 100. For example, in certain embodiments of the disclosure, the CPU 135 may include circuitry that determines the signal strength of the wireless network(s) (not shown) monitored by the module 100. The signal strength monitoring/determining circuitry is well known to one of ordinary skill in the art. The LCD display 105 may then receive the signal strength information and displays it to the user in a known manner. Accordingly, in certain embodiments, the user can optionally monitor the signal strength as displayed on the LCD display 105 and manually adjust the location of the module 100 in order to maximize the signal strength if desired. In a further embodiment, the LCD display 105 can show the signal strength of the cellular network. Generally, as will be recognized by those skilled in the art, when the communication module 100 is configured so as to be an integral component of an STB, it may be desirable to not include the optional LCD display. Alternatively, if module 100 is configured as an integral component of an STB, the optional LCD display may be an external component of the STB.

The module 100 has the capability to be attached to a local area network 150 and/or a wide area/broadband network 155 for communicating over a packet switched network, such as the Internet, either directly or indirectly. In certain embodiments, the module has one or more interfaces (e.g., RJ-11 jacks 160) to connect with a land-line telephone network (not shown), or one or more interfaces (e.g., RJ-45 jacks 162) to connect to a network hub (e.g., 10/100 BaseT Ethernet Hub) or switch (not shown) to connect to the local area network 150.

The module 100 may include a communications node configured to interface with the STB (not shown). In certain embodiments, module 100 may include a USB port 164 to connect, e.g., directly to an STB, via a USB connection. In yet other embodiments, all or some of the components discussed herein with respect to the module 100 may be integrated into an STB such that the STB performs some or all of the functionalities discussed herein with respect to the module 100. In yet other embodiments, module 100 may be configured as a stand-alone device including, e.g., a RJ-45 jack 162 or other suitable node, to allow for connection to an STB. However, any suitable communications node known in the art or hereinafter developed suitable for such purposes may be used, and the invention is not so limited. If desired, in all configurations, the STB may include additional ports for attachment to LANs, WANs, etc.

Once the location identifying information, such as latitude and longitude coordinates, have been determined, a database system (external or internal) may be queried by the CPU 135 to identify the corresponding closest address (or other location identifying information) for the module 100 based on the given latitude and longitude. For example, Google Maps provides a database and a set of APIs that may be used by the CPU 135 and/or an associated computer, STB or the like to determine the address corresponding to a given latitude and longitude. Other publicly accessible or proprietary databases may also be used. In certain embodiments, the CPU 135 may then cause the LCD display 105 to display location identifying information for the module 100, including the address information received from Google Maps or other database systems.

Alternatively, CPU 135 may prompt the STB to display the location identifying information via an output of the STB (e.g., via the output to a television or monitor to which the STB is attached). Once the CPU 135 determines a location of the module 100, it may, in connection with facilitating the determination of whether the use of the STB is authorized or to facilitate the delivery of location-specific content, transfer location identifying information to the media content service provider (e.g., a satellite television provider). The CPU 135 may implement said transfer as a cellular-based transfer via said cellular network using the cellular chip 130, a VoIP call via said packet switched network, a packet transfer via said packet switched network, or a landline telephone.

In an embodiment of the disclosure, the CPU 135 may execute software that routes communications via various methods depending on availability and preferences. For example, the CPU 135 may attempt cellular communication, VoIP or packet switch network communication, and/or landline telephony communication in any desired order. In one embodiment, if the CPU 135 determines that the cellular chip 130 can engage in two-way communication via the cellular network, then the CPU 135 proceeds to route the communication over a cellular network via the cellular chip. By way of example, the CPU 135 may determine that the cellular chip 130 can engage in two-way communication via the cellular network by determining if a cellular signal is present.

In an alternative embodiment, the CPU 135 may determine that the cellular chip 130 can engage in two-way communication via the cellular network by measuring the strength of a cellular signal and comparing it to a pre-determined standard. If the CPU determines that the cellular chip 130 cannot engage in two-way communication via the cellular network, then the CPU 135 may proceed to route the communication over the packet switched network.

In another embodiment, the CPU attempts to route the communication over a cellular network, and if the attempt fails, then the CPU 135 may proceed to route the communication over the packet switched network, via, for example, a router and/or broadband modem. If the CPU 135 then fails in the attempt to route via the packet switched network, then CPU 135 may proceed to route via a landline telephone. In the event that CPU 135 is unable to communicate via any communication mode, CPU 135 may optionally be configured to disable the STB, either immediately or after alerting the user to the inability to establish communication and allowing for remedial measures.

In other embodiments, CPU 135 may first attempt to communicate via packet-switched networks, then cellular networks, followed by landline telephony; or alternatively first via landline telephony, then packet-switched networks, followed by cellular networks; etc. The order of communication modality is not limiting.

In accordance with one embodiment of the present disclosure, the module may maintain a database of registered locations or the media content service provider may maintain a database of registered locations for the module 100. In alternative embodiments, location identifying information may be provided to a remote database, e.g., a third party service provider, which maintains a database of registered locations for the module 100. The remote database may, in turn, provide the location information directly to a media content service provider upon request. In all embodiments, although the local or remote database(s) may receive location information in the form of an address or as latitude and longitude, it can also convert the location information from latitude and longitude to address information, and vice-versa, and forward the same to the media content service provider (if applicable).

In accordance with one embodiment of the present disclosure, the location information that is forwarded to the media content service provider (or to another location specific service) in connection with the authorization activity or the service being provided will be either a registered location that is closest to the calculated location of the module 100, or closest to the calculated location if it is within a predetermined distance from the registered location. For instance, if the calculated location is within a predetermined distance of, e.g., 25, 50, 75, 100, 250, 500, etc. yards of a registered location, the calculated location can be treated as the registered location within the predetermined distance.

In certain embodiments, in connection with performing authorization activities, the CPU 135 may store registered location information in local memory and evaluate the calculated location of the module 100 (e.g., as calculated by the control logic, received from a remote database or third party) relative to the registered location information in local memory to determine whether the calculated location and the registered location are within a predetermined distance of each other. In other embodiments, registered location information may be stored remotely from the CPU 135, e.g., in a remote database or with a third party.

The registered location information may include one or more registered locations. If the calculated location of the module 100 is not a registered location or within a certain distance of a registered location, the CPU 135 may update the registered location to the calculated location, or may prompt a user to update the registered location information by noting the discrepancy between the calculated location and the registered location and, by way of example, selecting the most current calculated location of the module 100 as a suggested new registered location. The CPU 135 may prompt the STB to display a prompt for the user to update the registered location on the display 105 or via an output of the STB. The user may select the calculated location of the module 100, e.g., using a remote control device (not shown) associated with the STB. The CPU 135 may cause the location to be displayed to aid the user in selecting the current calculated location of the module 100 as a registered location.

Although the operation of the CPU 135 of the module 100 has been described above, it may be that one or more of each of the operations described above may be performed by the CPU of another device, such as an STB that is coupled to the module 100 or of which module 100 is a component.

One of ordinary skill in the art can appreciate that the module 100 requires AC or DC power in order to operate. By way of example and not limitation, the module can be powered from an AC electrical outlet or DC power source, such as the cigarette lighter in an automobile, a DC battery, or the USB port of an STB or computer.

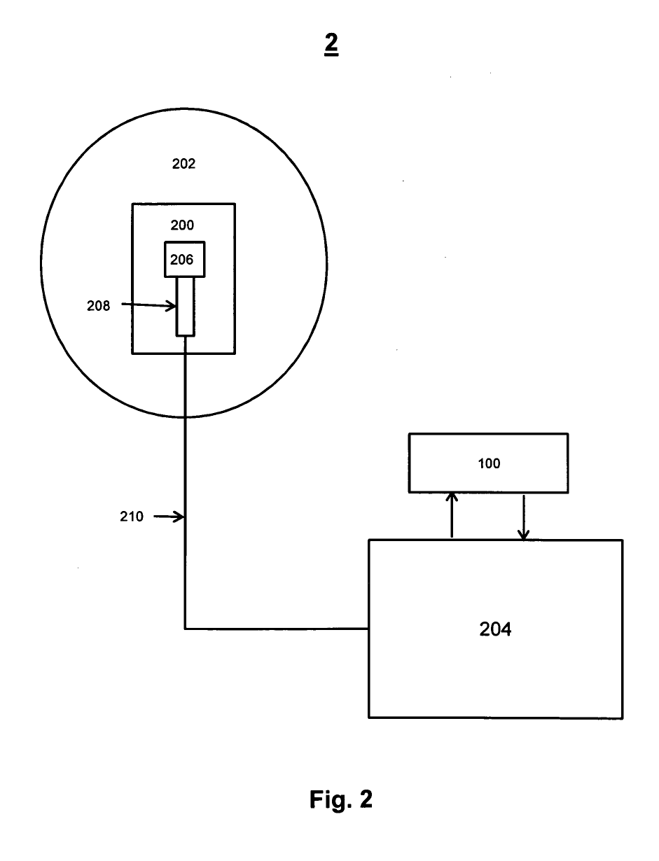

Referring to FIG. 2, a media content distribution network in accordance with certain embodiments of the disclosure is illustrated. The system generally comprises a satellite signal receiver 200 used in a digital television receiving system 2. The digital television receiving system 2 comprises a satellite dish 202, a satellite signal receiver 200 and an STB 204.

In a non-limiting example, an exemplary satellite television system is illustrated in further detail. As shown in FIG. 2, the satellite signal receiver 200 comprises an LNB (Low Noise Block-downconverter) 206 and a transmission controller 208. The STB 204 is connected to the transmission controller 208 by a coaxial cable 210. In other embodiments, the satellite television system may include a smart switch (not shown), as generally known in the art, and optionally may include multiple STBs (not shown) connected to satellite signal receiver 200.

The STB 204 is substantially similar to a conventional Set-Top-Box in hardware structure with the exception of integration of the communication module 100. However, as noted above, communication module 100 may alternatively be configured as a plug-n-play device or be configured as a stand alone device used in conjunction with an STB. As such, the invention is not so limited.

The built-in function/structure of the communication module 100 is described above with reference to FIG. 1. As described further below, in one embodiment, communication module 100 may be integrated with STB 204 to perform automated media content distribution authorization. For example, communication module 100 may be configured so as to determine the location of the STB 204, verify that the location is an authorized location, and automatically authorize distribution of media content if the location is authorized. The STB 204 may be configured in any manner known in the art so as to allow automatic authorization.

For example, STB 204 may be configured to power down media content output if communication module 100 determines the location to be unauthorized. Alternatively, STB 204 may be configured to only decode media content output if communication module 100 determines the location to be authorized. However, any suitable method known in the art may be used, and the invention is not so limited. In addition, as described herein, rather than automatic media content distribution authorization, communication module 100 may be configured so as to alert the media content service provider of use at an unauthorized location so as to facilitate manual or other authorization procedures by the media content service provider (e.g., the service provider may contact the user and inquire regarding use).

In yet other embodiments, the location specific authorization techniques may be used to monitor the locations of multiple associated STBs (e.g., a primary STB and “add-on” STBs). For instance, if a user has multiple STBs intended for use at a single, concurrent authorized location under a single billing scheme (often at a discounted rate), the location specific authorization techniques of the invention may be used to monitor and compare the locations of the multiple STBs to verify that the STBs are being used within a certain predefined distance of one another, e.g., within 25, 50, 100, etc. yards of each other, at a single latitude and longitude, at a single street address, etc.

In accordance with such methods, the location of a first STB may be determined as described herein; a location of a second, third, fourth, etc, STB may be determined as described herein; the locations may be compared to determine if the locations fall within a predetermined distance of each other. If the locations fall outside a predetermined distance of each other, one or more of the STBs (falling outside the predetermined distance) may be automatically or manually disabled, the location information may be communicated to the media content service provider, etc., as described herein with regard to authorization and registration. If desired, the locations may also be evaluated to determine if the locations are authorized, registered, etc., as described herein. In this manner, a media content service provider can ensure that a user is not using a first STB at a first location, e.g., at home, and a second “add-on” STB (billed at a discounted rate) at a second location, e.g., at a vacation home.

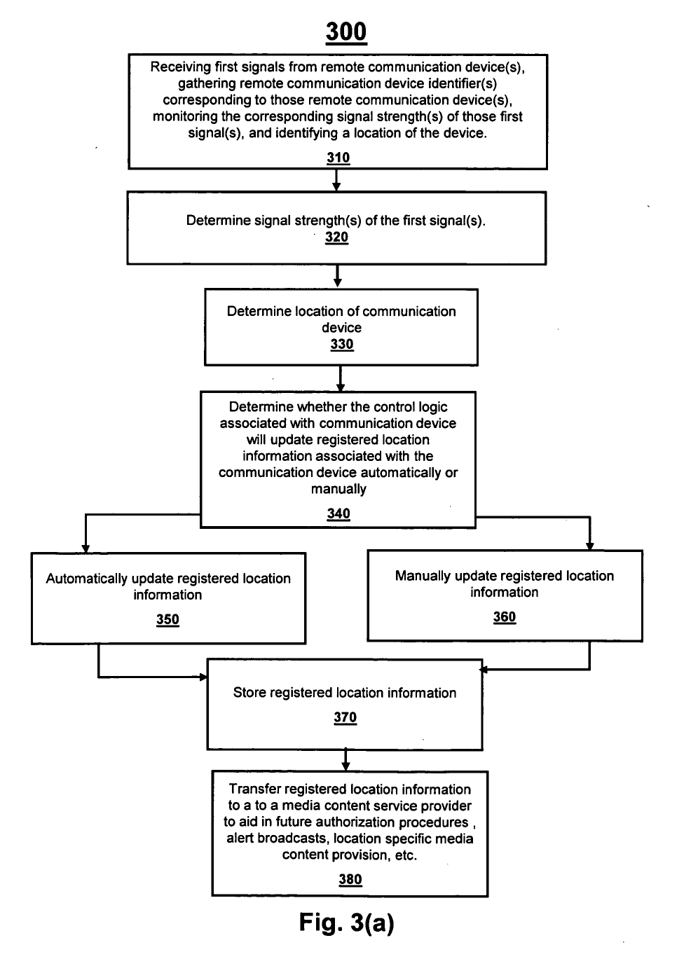

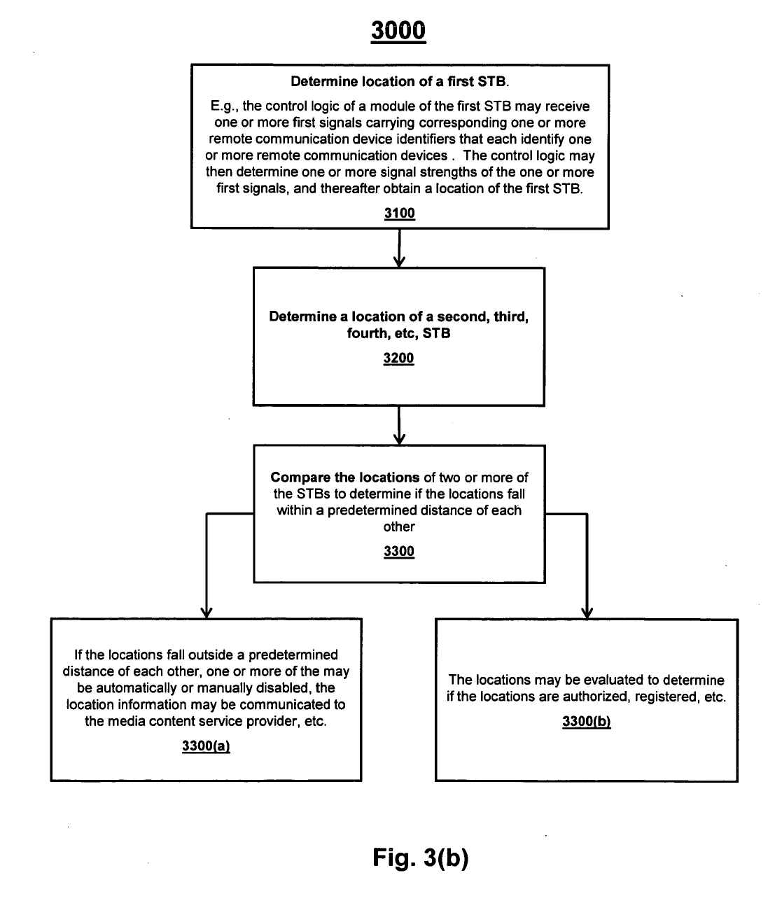

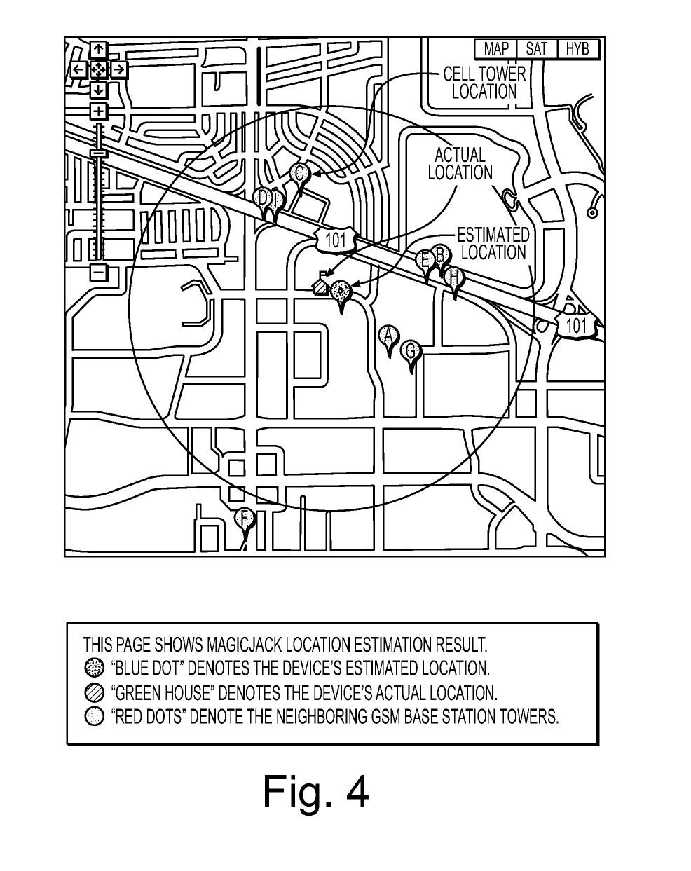

With reference to FIG. 3(a), a flow chart illustrating an exemplary embodiment is shown. Process 300 illustrates a method of determining a location of a module 100 using identifying information received from other remote communication devices, e.g., CMRS towers, wireless access points, and/or transmitters. While for the sake of clarity the discussion of FIGS. 3(a) and 3(b) and FIG. 4 will refer to determining the location of the module 100, it is not intended to be limiting and is equally applicable to determining the location of a STB, etc. In accordance with one exemplary embodiment, the module is provided for use with an STB, for integration with an STB, etc., and includes a receiver and/or transceiver and control logic (e.g., CPU 135 and/or other logic or computational circuitry).

In step 310, the control logic receives one or more first signals carrying corresponding one or more remote communication device identifiers (e.g., from cellular towers, transmitters, and/or wireless access point identifiers (e.g., MAC address)) that each identify one or more remote communication devices (e.g., CMRS towers, transmitters, and/or wireless access points). In step 320, the control logic determines one or more signal strengths of the one or more first signals. Thereafter, in step 330, the control logic determines a location of the module based on the one or more remote communication device identifiers (or one or more locations of the one or more remote communication devices) and the one or more signal strengths of the first signals from the remote communication devices.

More specifically, in step 330, the control logic uses the one or more remote communication device identifiers to obtain location information for the corresponding remote communication devices, and then based on the remote communication device location information and the one or more signal strengths calculates the location of the module. In certain embodiments, the control logic may output a second signal carrying the one or more identifiers to a remote device, server and/or database system (not shown), and receive a third signal carrying one or more locations of the remote communication devices associated with the remote communication device identifiers. In other embodiments the module may include a database of remote communication device locations. The second signal and/or third signal may be via any suitable communication medium, including via CMRS network, wireless network, LAN, WAN, landline telephony, etc.

However, it is noted that in certain embodiments (not shown) a remote device may be used to determine the actual location of the module, and the location can be communicated back to the control logic. By way of example, the control logic may output a second signal carrying the one or more identifiers and signal strengths, the location information may be calculated by a remote server and/or database system (not shown), and the calculated location may be returned to the control logic in a third signal. Again, the second signal and/or third signal may be via any suitable communication medium, including via CMRS network, wireless network, LAN, WAN, landline telephony, etc.

In yet other embodiments, a remote device may be used to determine the actual location of the module, and the remote device may then proceed, e.g., to evaluate whether the module (and therefore an associated STB) is being used at an authorized location, without communicating the location back to the control logic. By way of example, the control logic may output a second signal carrying the one or more identifiers and signal strengths, and the location information may be calculated by a remote server and/or database system (not shown). The second signal may be via any suitable communication medium, including via CMRS network, wireless network, LAN, WAN, landline telephony, etc. The remote device may then disable the STB, etc. as described herein, if use at the location is unauthorized. For instance, media content may no longer be sent to the STB, or may not be sent to the STB in a viewable format, etc.

In step 340, it is determined whether the control logic will update registered location information associated with the module automatically or manually. Alternatively, the location information may be obtained from a database integrated into the module 100, STB 204 or other local memory (not shown).

In step 350, if desired, the control logic updates the registered location information automatically. The registration ensures that media content service providers, e.g., digital or satellite television service providers, will have identifying information for a particular location at which the module (and therefore an associated STB) may be found. The control logic may store one or more prior registered locations for the module in memory and may update the registered location information as new location information is determined by the methods and techniques described herein. Again, the calculation of the location of the device may occur within the control logic, or may be done externally, e.g., by the media content service provider, by a location positioning service, etc., which may transfer relevant location information to the control logic.

The update of the registered location information includes assigning the calculated location of the module as a new registered location of the module. In accordance with one aspect of a preferred embodiment, a new registered location of the module is only assigned if the calculated location of the module is more than a predetermined distance from a registered location that has previously been assigned to the module. If it is not, then the registered location will be the closest previously assigned registered location stored in the local memory coupled to the control logic. This is done out of a recognition that the calculated location of the module is only an estimate and may not be the actual location of the module. In some instances a location, which was previously identified as the registered location and which is very close to the calculated location, may be treated as the actual location of the module.

If the update is not performed automatically, then in step 360 a user of the module may be prompted to update the location information of the module using the calculated location of the module. In certain embodiments, the location of the module may be selected from pre-designated registered location information of the module. A display may be provided for the module or provided via the output of the STB, and the control logic may cause the display to display different and user selectable options for the registered location including the newly calculated location. In any event, the updating of registered location information need not be done incident to authorization of use of the STB, but may be done in advance to facilitate timely updates to the registered location information that may be stored in memory associated with the module or some other device coupled thereto.

Once one or more registered locations for the module are stored in memory (or a remote database) in step 370, they are available for later use and may be transferred in step 380 to a media content service provider (to aid in future authorization procedures should the user move the module and/or STB between authorized locations, to facilitate alert broadcast, and/or location specific media content provision, etc.) via a cellular network, a packet switched network, landline telephony, etc. As an alternative to the use of a registered location, the calculated location may be transferred without being registered.

In yet other embodiments, the location specific authorization techniques may be used to monitor the locations of multiple associated modules, STBs, etc. (e.g., a primary STB and “add-on” STBs). With reference to FIG. 3(b), a flow chart illustrating an exemplary embodiment is shown. Process 3000 illustrates a method of determining a location of multiple STBs using identifying information received from other remote communication devices, e.g., CMRS towers, wireless access points, and/or transmitters. For instance, if a user has multiple STBs intended for use at a single, concurrent authorized location under a single billing scheme (often additional STBs at a single location qualify for a discounted rate), the location specific authorization techniques of the invention may be used to monitor and compare the locations of the multiple STBs to verify that the STBs are being used within a certain predefined distance of one another, e.g., within 25, 50, 100, etc. yards of each other, at a single latitude and longitude, at a single street address, etc.

In accordance with process 3000, at step 3100, the location of a first STB may be determined as generally described herein. For example, the control logic of a module of the first STB may receive one or more first signals carrying corresponding one or more remote communication device identifiers (e.g., from cellular towers, transmitters, and/or wireless access point identifiers (e.g., MAC address)) that each identify one or more remote communication devices (e.g., CMRS towers, transmitters, and/or wireless access points). The control logic may then determine one or more signal strengths of the one or more first signals, and thereafter obtain a location of the first STB. Any of the methods described herein for obtaining the location of the first STB may be used.

Concurrently or sequentially with step 3100, at step 3200, a location of a second, third, fourth, etc, STB may be determined as described herein. Again, by way of example, the control logic of a module of the respective STBs may receive one or more first signals carrying corresponding one or more remote communication device identifiers that each identify one or more remote communication devices. The control logic may then determine one or more signal strengths of the one or more first signals, and thereafter obtain a location of the respective STBs. Any of the methods described herein for obtaining the location of the STBs may be used.

Once the locations of the STBs are obtained in steps 3100 and 3200, at step 3300, the locations of two or more of the STBs may be compared to determine if the locations fall within a predetermined distance of each other. For example, the location of the first STB obtained in step 3100 may be compared to the location of one or more STBs obtained in step 3200, to determine if the locations fall within a predetermined distance of each other, e.g., within 25, 50, 100, etc. yards of each other, at a single latitude and longitude, at a single street address, etc. Alternatively, the location of a second, third, fourth, etc. STB, as obtain in step 3200, may be compared to one another to verify that two or more of the STBs are within a predetermined distance of one another.

In certain embodiments, at step 3300(a), if the locations fall outside a predetermined distance of each other, one or more of the STBs (falling outside the predetermined distance) may be automatically or manually disabled, the location information may be communicated to the media content service provider, etc., as described herein with regard to authorization and registration. In other embodiments, at step 3300(b), if desired, the locations may also be evaluated to determine if the locations are authorized, registered, etc., as described herein. In this manner, a media content service provider can ensure that a user is not using without authorization a first STB at a first location, e.g., at home, and a second “add-on” STB (billed at a discounted rate) at a second location, e.g., at a vacation home.

FIG. 4 depicts location identifying information for different components within a cellular network that illustrates the use of an exemplary embodiment of the disclosure. In addition, signal strength information associated with cellular communications within the cellular network is also depicted in FIG. 4. In particular, FIG. 4 depicts the location of remote communication devices (i.e., cellular towers shown as red dots), and the actual and estimated location of a module (i.e., a module whose actual location is shown as a green house and whose estimated location is shown as a blue dot). The estimated location of the module is calculated in accordance with triangulation techniques that are well known in the art, as noted above. Additional location identifying information for the module is shown along with signal strength information for signals transmitted by the remote communication devices (i.e., the cellular towers) and received by the module. The location identifying information for the module may be displayed to facilitate the update of registered location information in the manner described above. It is noted that wireless access points and/or other transmitters may also be used to provide location and signal information in addition to the cellular towers depicted.

In yet another aspect of the disclosure, location information may be used by a media content service provider to supply location specific alerts. For example, in connection with the location and authorization devices and methods, the present disclosure provides a missing persons and advisory alert system which may be used to transmit geographically specific alerts.

The module 100 may be used in connection with an STB capable of displaying or broadcasting location specific alerts or advertisements or programming. In connection with the location information determined by the module 100, the media content service provider may reliably target alerts or advertisements to appropriate geographical locations. In this regard, an STB may be configured to accept the transmission on a priority status, e.g., provide notice by interrupting a television program, employing a pop-up screen, use of a ticker tape display, notification of receipt of electronic mail, providing targeted advertising, etc. Alerts and advertising and programming may be targeted to a particular STB or to all STBs in an area based on last known registered location, updates received from module 100, user prompts from STB based on data received from module 100, etc. As discussed above, the geographical location can be longitude and latitude coordinates, street addresses, etc.

An advisory alert may be triggered by an event, such as a missing person, missing pet, emergency situation, local storm warning, etc. The broadcast of the advisory alert is generally initiated at a central notification computer. A geographic area having a defined perimeter is associated with the advisory alert. An algorithm is then generally employed at the central notification computer to retrieve the addresses of the Digital Cable and Satellite Television or similar electronic devices for the subscribers associated with the locations within the defined perimeter. The affected subscribers can be more specifically identified based on the location information received from the devices of the present disclosure. The advisory alert is then transmitted, optionally in both video and audio formats to the affected subscriber addresses. Location-specific program content or advertising may also be directed at STBs determined to be located within geographic areas.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims, in which all terms are meant in their broadest reasonable sense unless otherwise indicated therein.

We claim:

1) A module configured to interface with a device that receives media content, the module comprising:
a node configured to interface with the device that receives media content;
a receiver and/or transceiver that receives one or more first signals carrying corresponding one or more commercial mobile radio service (CMRS) tower, wireless access point (WAP), and/or transmitter identifiers that each identify one or more CMRS towers, WAPs, and/or transmitters; and
control logic that receives, via the receiver and/or transceiver, the one or more first signals, determines one or more signal strengths of the one or more first signals, and obtains a location of the device to facilitate the provision of location specific services or information alerts and/or the determination of whether a use of the device at the location is authorized.

2) The module of claim 1, wherein the module is integrated with the device that receives media content as one or more internal components of the device.

3) The module of claim 1, wherein the node is a universal serial bus (USB) or RS-45 jack.

4) The module of claim 1, wherein the control logic makes the determination of whether the use of the device at the location is authorized.

5) The module of claim 1, wherein a remote device makes the determination of whether the use of the device at the location is authorized.

6) The module of claim 1, wherein the control logic transfers a notification to a remote device.

7) The module of claim 6, wherein the notification indicates a result of the determination of whether the use of the device at the location is authorized.

8) The module of claim 6, wherein the notification indicates the location of the device.

9) The module of claim 6, wherein the notification indicates the one or more CMRS tower, WAP, and/or transmitter identifiers and the one or more signal strengths.

10) The module of claim 1, wherein one or more functions of the device are disabled if use of the device at the location is not authorized.

11) The module of claim 10, wherein the control logic of the module disables the one or more functions of the device.

12) The module of claim 10, wherein a remote device disables the one or more functions of the device.

13) The module of claim 1, wherein the control logic causes to be outputted one or more second signals carrying the one or more identifiers and receives one or more third signals carrying one or more locations of the CMRS towers, WAPs, and/or transmitters having the one or more identifiers, and wherein the control logic determines a location of the device using the one or more locations of the CMRS towers, WAPs, and/or transmitters, and the one or more signal strengths of the one or more first signals.

14) The module of claim 13, wherein the one or more locations of the CMRS towers, WAPs, and/or transmitters are received from a remote database.

15) The module of claim 1, wherein the control logic correlates the one or more identifiers to one or more locations of the CMRS towers, WAPs, and/or transmitters having the one or more identifiers and calculates the location of the device based on the locations and the signal strengths.

16) The module of claim 15, wherein the module further comprises a database of locations including locations of CMRS towers, WAPs, and/or transmitters, and the one or more locations of the CMRS towers, WAPs, and/or transmitters are retrieved from the database of locations using the one or more identifiers.

17) The module of claim 1, wherein the control logic outputs one or more second signals carrying the one or more identifiers and the one or more signal strengths to a remote device and the control logic receives one or more third signals from the remote device carrying information relating to the location of the device.

18) The module of claim 1, wherein the location of the device is compared to registered location information of the device to determine if use of the device at the location is authorized.

19) The module of claim 18, wherein the registered location information is stored in a memory of the module or the device.

20) The module of claim 18, wherein the registered location information is stored in a memory that is remote from the module and the device.

21) The module of claim 18, wherein the location of the device is compared to the registered location information of the device by the control logic.

22) The module of claim 18, wherein the location of the device is compared to the registered location information by a remote device.

23) The module of claim 1, wherein the location of the device is used by a user of the device to update registered location information of the device.

24) The module of claim 23, wherein the update is performed by the module without user intervention.

25) The module of claim 23, wherein a notification is displayed on a display to prompt a user to update the registered location information of the device.

26) The module of claim 23, wherein the location of the device is used by a user of the device to update the registered location information of the device with the aid of the display upon which the location of the device is depicted.

27) The module of claim 23, wherein the update of the registered location information comprises assigning the location of the device as a new registered location of the device if the location is more than a predetermined distance from an existing registered location previously assigned to the device.

28) The module of claim 23, wherein the control logic outputs a notification to a user of the device to request that the user update the registered location information of the device.

29) The module of claim 1, wherein the device is a satellite set top box and the media content is received as direct broadcast satellite television signals.

30) The module of claim 1, wherein the media content is received as broadcast television signals.

31) The module of claim 1, wherein the media content is received as subscription programming signals.

32) The module of claim 1, wherein the location specific services or information alerts are received from a remote device.

33) The module of claim 32, wherein the location specific services or information alerts comprise location specific media content.

34) The module of claim 33, wherein the location specific media content is selected from the group consisting of location specific programming, advertising, alerts, and combinations thereof.

35) A method of locating a device that receives media content, the method comprising:
receiving one or more first signals carrying corresponding one or more CMRS tower, WAP, and/or transmitter identifiers that each identify one or more CMRS towers, WAPs, and/or transmitters;
determining one or more signal strengths of the one or more first signals; and
obtaining a location of the device to facilitate provision of location specific services or information alerts to the device and/or determination of whether a use of the device at the location is authorized.

36) The method of claim 35, wherein the device makes the determination of whether the use of the device at the location is authorized.

37) The method of claim 35, wherein a remote device makes the determination of whether the use of the device at the location is authorized.

38) The method of claim 35, wherein the device transfers a notification to a remote device.

39) The method of claim 38, wherein the notification indicates a result of the determination of whether the use of the device at the location is authorized.

40) The method of claim 38, wherein the notification indicates the location of the device.

41) The method of claim 38, wherein the notification indicates the one or more CMRS tower, WAP, and/or transmitter identifiers and the one or more signal strengths.

42) The method of claim 35, further comprising disabling one or more functions of the device if use of the device at the location is not authorized.

43) The method of claim 42, wherein the device performs the act of disabling one or more functions of the device.

44) The method of claim 42, wherein a remote device performs the act of disabling one or more functions of the device.

45) The method of claim 35, further comprising outputting a second signal carrying the one or more identifiers and receiving a third signal carrying one or more locations of the CMRS towers, WAPs, and/or transmitters having the one or more identifiers, and determining a location of the device using the one or more locations of the CMRS towers, WAPs, and/or transmitters and the one or more signal strengths of the one or more first signals.

46) The method of claim 45, wherein the one or more locations of the WAPs, CMRS towers, and/or transmitters are received from a remote database.

47) The method of claim 35, further comprising correlating the one or more identifiers to one or more locations of the CMRS towers, WAPs, and/or transmitters having the one or more identifiers and calculating the location of the device based on the locations and the signal strengths.

48) The method of claim 47, wherein the device comprises a database of locations including locations of CMRS towers, WAPs, and/or transmitters, and the one or more locations of the CMRS towers, WAPs, and/or transmitters are retrieved from the database of locations using the one or more identifiers.

49) The method of claim 35, further comprising outputting one or more second signals carrying the one or more identifiers and the one or more signal strengths to a remote device, and receiving one or more third signals from the remote device carrying information relating to the location of the device based on the one or more locations and signal strengths.

50) The method of claim 35, wherein the location of the device is compared to a registered location information of the device to determine if use of the device at the location is authorized.

51) The method of claim 50, wherein the registered location information is stored in a memory of one of the device.

52) The method of claim 50, wherein the registered location information is stored in a memory that is remote from the device.

53) The method of claim 50, wherein the location of the device is compared to the registered location information by the device.

54) The method of claim 50, wherein the location of the device is compared to the registered location information by a remote device.

55) The method of claim 35, wherein the location of the device is used to update a registered location information of the device.

56) The method of claim 55, wherein the update is performed by the device without user intervention.

57) The method of claim 55, wherein a notification is displayed on a display to prompt a user to update the registered location information of the device.

58) The method of claim 55, wherein the location of the device is used by a user of the device to update the registered location information of the device with the aid of a display upon which the location of the device is depicted.

59) The method of claim 55, wherein the update of the registered location information comprises assigning the location of the device as a new registered location of the device if the location is more than a predetermined distance from an existing registered location previously assigned to the device.

60) The method of claim 55, further comprising outputting a notification to a user of the device to request that the user update the registered location information of the device.

61) The method of claim 35, wherein the device is a satellite set top box and the media content is received as direct broadcast satellite television signals.

62) The method of claim 35, wherein the media content is received as broadcast television.

63) The method of claim 35, wherein the media content is received as subscription programming.

64) The method of claim 35, wherein the provision of location specific services or information alerts further comprises receiving location specific services or information alerts from a remote device.

65) The method of claim 64, wherein the location specific services or information alerts comprise location specific media content.

66) The method of claim 65, wherein the location specific media content is selected from the group consisting of location specific programming, advertising, alerts, and combinations thereof.

67) A media content set top box for receiving media content, the media content set top box comprising:
a receiver and/or transceiver that receives one or more first signals carrying corresponding one or more CMRS tower, WAP, and/or transmitter identifiers that each identify one or more CMRS towers, WAPs, and/or transmitters; and
control logic that receives, via said receiver and/or transceiver, the one or more first signals, determines one or more signal strengths of the one or more first signals, and obtains a location of the media content set top box, wherein the location of the media content set top box is used to provide location specific media content or information alerts and/or to facilitate determination of whether use of the media content set top at the location is authorized.

68) The media content set top box of claim 67, wherein the media content set top box is a satellite set top box and the media content is received as direct broadcast satellite television signals.

69) The media content set top box of claim 67, wherein the media content is received as broadcast television signals.

70) The media content set top box of claim 67, wherein the media content is received as subscription programming signals.

71) The media content set top box of claim 67, wherein the control logic makes the determination of whether the use of the media content set top box at the location is authorized.

72) The media content set top box of claim 67, wherein a remote device makes the determination of whether the use of the media content set top box at the location is authorized.

73) The media content set top box of claim 67, wherein the control logic transfers a notification to a remote device.

74) The media content set top box of claim 73, wherein the notification indicates a result of the determination of whether the use of the media content set top box at the location is authorized.

75) The media content set top box of claim 73, wherein the notification indicates the location of the media content set top box.

76) The media content set top box of claim 73, wherein the notification indicates the one or more CMRS towers, WAP, and/or transmitter identifiers and the one or more signal strengths.

77) The media content set top box of claim 67, wherein one or more functions of the media content set top box are disabled if use of the device at the location is not authorized.

78) The media content set top box of claim 77, wherein the control logic of the media content set top box disables the one or more functions of the media content set top box.

79) The media content set top box of claim 77, wherein a remote device disables the one or more functions of the media content set top box.

80) The media content set top box of claim 67, wherein the control logic causes to be outputted one or more second signals carrying the one or more identifiers and receives one or more third signals carrying one or more locations of the CMRS towers, WAPs, and/or transmitters having the one or more identifiers, and wherein the control logic determines a location of the media content set top box using the one or more locations of the CMRS towers, WAPs, and/or transmitters, and the one or more signal strengths of the one or more first signals.

81) The media content set top box of claim 80, wherein the one or more locations of the CMRS towers, WAPs, and/or transmitters are received from a remote database.

82) The media content set top box of claim 67, wherein the control logic correlates the one or more identifiers to one or more locations of the CMRS towers, WAPs, and/or transmitters having the one or more identifiers and calculates the location of the media content set top box based on the locations and the signal strengths.

83) The media content set top box of claim 80, wherein the media content set top box further comprises a database of locations including locations of CMRS towers, WAPs, and/or transmitters, and the one or more locations of the CMRS towers, WAPs, and/or transmitters are retrieved from the database of locations using the one or more identifiers.

84) The media content set top box of claim 67, wherein the control logic outputs one or more second signals carrying the one or more identifiers and the one or more signal strengths to a remote device and the control logic receives one or more third signals from the remote device carrying information relating to the location of the device.

85) The media content set top box of claim 67, wherein the location of the media content set top box is compared to a registered location information of the media content set top box to determine if use of the media content set top box at the location is authorized.

86) The media content set top box of claim 83, wherein the registered location information is stored in a memory of the media content set top box.

87) The media content set top box of claim 83, wherein the registered location information is stored in a memory that is remote from the media content set top box.

88) The media content set top box of claim 83, wherein the location of the device is compared to the registered location information of the media content set top box by the control logic.

89) The media content set top box of claim 83, wherein the location of the media content set top box is compared to the registered location information by a remote device.

90) The media content set top box of claim 67, wherein the location of the media content set top box is used by a user of the media content set top box to update registered location information of the media content set top box.

91) The media content set top box of claim 90, wherein the update is performed by the media content set top box without user intervention.

92) The media content set top box of claim 90, wherein a notification is displayed on a display to prompt a user to update the registered location information of the media content set top box.

93) The media content set top box of claim 90, wherein the location of the media content set top box is used by a user of the media content set top box to update the registered location information of the media content set top box with the aid of the display upon which the location of the media content set top box is depicted.

94) The media content set top box of claim 90, wherein the update of the registered location information comprises assigning the location of the media content set top box as a new registered location of the media content set top box if the location is more than a predetermined distance from an existing registered location previously assigned to the media content set top box.

95) The media content set top box of claim 90, wherein the control logic outputs a notification to a user of the media content set top box to request that the user update the registered location information of the media content set top box.

96) The media content set top box of claim 67, wherein the location specific services or information alerts are received from a remote device.

97) The media content set top box of claim 96, wherein the location specific services or information alerts comprise location specific media content.

98) The media content set top box of claim 97, wherein the location specific media content is selected from the group consisting of location specific programming, advertising, alerts, and combinations thereof.

99) A method for determining location identifying information for a media content set top box that receives media content, the method comprising:
receiving, via a receiver and/or transceiver associated with the media content set top box, one or more first signals carrying corresponding one or more CMRS tower, wireless access point, and/or transmitter identifiers that each identify one or more CMRS towers, wireless access points, and/or transmitters;
determining one or more signal strengths of the one or more first signals; and
obtaining a location of the media content set top box, wherein the location of the media content set top box is used to provide location specific media content or information alerts and/or to facilitate determination of whether use of the media content set top box at the location is authorized.

100) The method of claim 99, wherein one or more functions of the media content set top box are disabled if it is determined that the use of the media content set top box is not authorized.

101) The method of claim 99, wherein the location of the media content set top box is used to update a registered location information of the media content set top box, wherein the update of the registered location information comprises assigning the location of the media content set top box as a new registered location of the media content set top box.

102) The method of claim 99, wherein the location of the media content set top box is used to update registered location information associated with the media content set top box, wherein the update of the registered location information comprises assigning the location of the media content set top box as a new registered location of the media content set top box only if the location is more than a predetermined distance from a registered location that has previously been assigned to the media content set top box.

103) The method of claim 99, further comprising outputting a notification to a user of the media content set top box to update registered location information based on the location of the media content set top box.

104) A system that includes a media content set top box that receives media content and a remote device, the system comprising:
a media content set top box comprising a receiver and/or transceiver and control logic; and
a remote device;
wherein the control logic of the media content set top box: (a) receives one or more first signals, via the receiver and/or transceiver, carrying corresponding one or more CMRS tower, wireless access point, and/or transmitter identifiers that each identify one or more CMRS towers, wireless access points, and/or transmitters, (b) determines one or more signal strengths of the one or more first signals, and (c) obtains a location of the media content set top box;
wherein the location of the media content set top box is communicated to the remote device, and the remote device provides location specific services or information alerts and/or facilitates determination of whether use of the media content set top box is authorized based on the calculated location.

105) The system of claim 104, wherein the control logic determines the location of the media content set top box.

106) The system of claim 104, wherein the control logic outputs a second signal carrying the one or more identifiers and receives a third signal carrying one or more locations of the CMRS towers, WAPs, and/or transmitters having the one or more identifiers, and wherein the control logic determines a location of the media content set top box using the one or more locations of the CMRS towers, WAPs, and/or transmitters, and the one or more signal strengths of the one or more first signals.

107) The system of claim 104, wherein the one or more locations of the CMRS towers, WAPs, and/or transmitters are received from a remote database.

108) The system of claim 104, wherein the control logic correlates the one or more identifiers to one or more locations of the CMRS towers, WAPs, and/or transmitters having the one or more identifiers and calculates the location of the media content set top box based on the locations and the signal strengths.

109) The system of claim 108, wherein the media content set top box further comprises a database of locations including locations of CMRS towers, WAPs, and/or transmitters, and the one or more locations of the CMRS towers, WAPs, and/or transmitters are retrieved from the database of locations using the one or more identifiers.

110) The system of claim 104, wherein the remote device determines the location of the media content set top box.

111) The system of claim 104, wherein the control logic outputs a second signal carrying the one or more identifiers and the one or more signal strengths to the remote device.

112) The system of claim 104, wherein the control logic outputs a second signal carrying the one or more identifiers and the one or more signal strengths to the remote device, and receives a third signal from the remote device carrying information relating to the location of the media content set top box based on the information.
